(19) United States
(12) Patent Application Publication
(10) Pub. No.: US 2015/0261465 A1
(43) Pub. Date: Sep. 17, 2015

(54) SYSTEMS AND METHODS FOR STORAGE AGGREGATES AND INFINITE STORAGE VOLUMES

(71) Applicant: NetApp, Inc., Sunnyvale, CA (US)

(72) Inventors: James Namboorikandathil Joseph, Bangalore (IN); Vishal Kanaujia, Bangalore (IN); Chetan Jayant Giridhar, Bangalore (IN)

(21) Appl. No.: 14/589,736

(22) Filed: Jan. 5, 2015

(30) Foreign Application Priority Data
Feb. 21, 2014 (IN) 500/DEL/2014

(51) Int. Cl. G06F 3/06

(52) U.S. Cl. CPC G06F 3/0619; G06F 3/0686; G06F 3/065

(57) ABSTRACT

A method of storing data to an aggregate storage system including: receiving data at the aggregate storage system, wherein the aggregate storage system includes a random-access storage component and a sequential-access storage component, and wherein the data includes one or more data portions and one or more metadata portions; identifying each portion of the data as either one of the data portions or one of the metadata portions; in response to determining that one of the metadata portions is identified, writing the metadata portion to the random-access storage component and the sequential-access storage component; and in response to determining that one of the data portions is identified, writing the data portion only to the sequential-access storage component.

### CROSS-REFERENCE

The present application claims priority to Indian Patent Application No. 500/DEL/2014, entitled “Systems and Methods for Storage Aggregates and Infinite Storage Volumes,” filed on Feb. 21, 2014, the entirety of which is hereby incorporated by reference.

### TECHNICAL FIELD

The present disclosure relates generally to infinite data storage systems and specifically to infinite data storage systems that utilize sequential access storage devices.

### BACKGROUND

Sequential-access storage devices such as magnetic tape drives are the lowest level of memory hierarchy. Sequential-access storage devices differ from random-access storage devices because data stored on a sequential-access device is read from and written to the drive medium in a sequential or linear way. For example, magnetic tape drives read and write data to the magnetic medium sequentially as the tape runs. The speed at which any particular data may be read from or written to the tape directly depends on the current position of the tape head in relation to where on the tape the data is stored. In order to read data from or write data to a particular position on the tape, the desired location must be found with a seek operation that rotates the tape's reels to the correct position. Tapes and other sequential-access devices differ from random-access devices in that the speed at which data is read from or written to a random-access device is relatively constant regardless of the data's position on the device.

Traditionally, sequential storage devices are used for tertiary storage operations such as backup, archival storage, and disaster recovery, but not for primary or secondary storage operations such as random-access file I/O operations. One such attempt to convert sequential storage devices to secondary storage is the Linear Tape File System (“LTFS”) (provided by International Business Machines of Armonk, N.Y.). The LTFS Format defines the organization of data and metadata on sequential storage devices (i.e., files stored in hierarchical directory structure).

Sequential-access devices are generally not suitable for random-access operations such as file system I/O operations. Because they use sequential I/O (sequential read/writes) operations, sequential-access storage devices have high access times and independent units of storage which make file I/O operations prohibitively slower than random-access storage devices. Further, sequential-access device management is usually carried out by third party vendors with proprietary software (e.g., NetBackup provided Symantec Corp. of Mountain View, Calif. and Simpana provided by CommVault of Oceanport, N.J.). Even with these solutions, however, sequential-access devices are still only accessible via sequential I/O operations and backup is not available via an ordinary file system interface. Only providing a sequential I/O interface, therefore, limits the ability to backup and restore individual data files with sequential-access devices rather than an entire storage volume.

Accordingly, it would be desirable to have a data backup solution where a sequential-access device is available not only through a sequential I/O interface but also as a file system interface that supports random-access I/O operations at access speeds similar to those used with traditional random-access storage drives.

### BRIEF DESCRIPTION OF THE DRAWINGS

FIG. 1 illustrates a diagram of an example a tape aggregate storage system according to some embodiments.

FIG. 2 is a simplified block diagram of a system that shows an example relationship between an infinite storage system and an infinite tape aggregate storage system.

FIG. 3 illustrates an example method for reading data from a tape aggregate storage system according to some embodiments.

FIG. 4 illustrates an example method for writing data to a tape aggregate storage system according to some embodiments.

FIG. 5 illustrates an example method for storing data received by a tape aggregate storage system according to some embodiments.

FIG. 6 illustrates an example method for retrieving data from a tape aggregate storage system according to some embodiments.

### DETAILED DESCRIPTION

In the following description, specific details are set forth describing some embodiments consistent with the present disclosure. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Various embodiments of the present disclosure provide methods for reading and writing data at a storage system that uses, in part, sequential-access storage devices. The embodiments not only provide sequential I/O operations traditionally used with sequential-access storage devices such as, for example, magnetic tapes, but also provide random-access I/O operations such as, for example, file system operations that allow access to the serial devices as if they were random-access devices. To accomplish this, the storage system includes one or more random-access drives for storing metadata and one or more sequential-access drives (e.g., magnetic tape drives) for storing both data and metadata. The metadata stored in both the random-access drives and the sequential-access drives includes properties about the data such as, for example, file attributes, storage locations, and other information. The metadata is stored on the sequential-access drives in addition to the random-access drives should the need arise to restore corrupted metadata stored on the random-access drives. The data stored on the sequential-access drives includes the actual contents of the data files requested to be stored.

Storing the metadata in a random-access storage device enables the storage system to offer I/O operations to the tape aggregate storage system as if it was random-access storage system. In other words, because the metadata is stored on random-access drives in addition to the sequential-access drives, accessing a file listing or the attributes of a specific file is relatively quick operation. In this way, backup solutions can use file system level I/O commands to backup and restore data using the storage system rather than being limited to sequential I/O commands provided by convention sequential-access storage devices.

The example embodiments below refer to “disks” and “disk drives” and “tapes” and “tape drives.” The scope of the embodiments, however, is not intended to be so limiting. For example “disks” and “disk drives” may include one or more random-access storage devices that provide fast access to nonvolatile data. Example disk drives may include magnetic hard drives, solid state hard drives, and flash memory devices. Similarly, “tapes” and “tape drives” may include one or more sequential-access storage devices that provide sequential or linear access to the data stored on the devices. Example tape drives may include magnetic tape drives or any other sequential-access storage device for storing non-volatile data. The embodiments may also include first and second media storage components that are either random-access storage components or sequential-access storage components. For example, while the embodiments described below include storing metadata on a disks and data and metadata on tapes, it is within the scope of the embodiments to store data and metadata on a second media storage component that includes either disk or tape devices.

In some embodiments, the storage system can be configured to mirror a secondary level storage system (e.g., random-access based storage system). For example, a large disk-based storage system may include one or more virtual data volumes that map to the physical storage blocks of the disk drives. The storage systems described in the embodiments can mirror the virtual data volumes of the disk-based system in the same way. In other words, a backup can be created to mirror the virtual volumes of the disk-based system using magnetic tape-based virtual volumes. In the storage systems of the embodiments, for example, the magnetic tape-based virtual volumes appear as regular disk-based volumes but store the backed-up data on magnetic tape drives and the backed-up metadata on both regular disk drives and the magnetic tape drives.

While the example provided above discusses a single storage system, it should be noted that the scope of embodiments is not so limited. For example, multiple storage systems can be combined into a single storage cluster such that each storage system is implemented using a node in a multi-node computer cluster where each node is configured to behave as a single storage device. In this case, a virtual data volume stored on a multi-node cluster can be configured such that the virtual data volume spans one or more of the sequential-access drives in one or more of the nodes. Thus, the embodiments described herein are highly adaptable based on the desired storage and backup needs of a user.

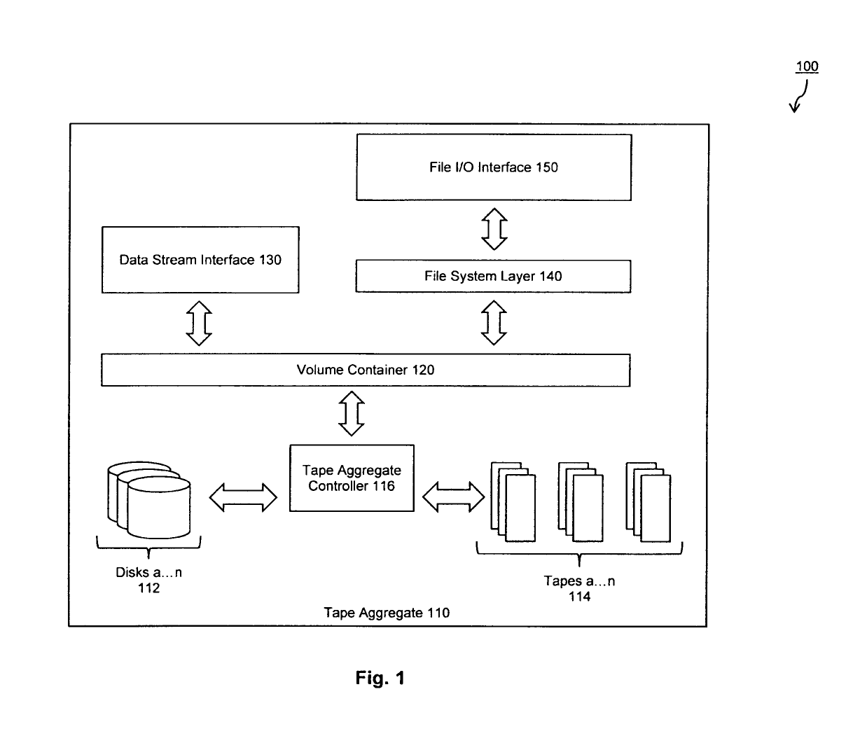

FIG. 1 illustrates a diagram of an example tape aggregate storage system 100 according to some embodiments. Storage system 100 may be implemented by one or more computer systems that include computer processors and memory. Storage system 100 may be implemented as, for example, a Network Attached Storage (NAS) system or a Storage Area Network (SAN) system that is accessible to remote clients. Storage system 100 may also be implemented as a web server or another type of server available via a network. While not shown in FIG. 1, the network can include any network capable of transmitting data between computer systems. Such networks may include, for example, a local area network (LAN), an Ethernet subnet, a PCI or PCIe subnet, a switched PCIe subnet, a wide area network (WAN), a metropolitan area network (MAN), the Internet, or the like.

Storage system 100 also includes tape aggregate 110 that include tape aggregate controller 116, at least one or more disks 112, and one or more tapes 114. Tape aggregate controller 116 is configured to allow read and write access to data on disks 112 and tapes 114. Controller 116 can be configured to implement a number of file system formats and I/O operations. Controller 116 can also be configured to execute an operating system that includes file system formats and I/O operations. Such operating systems may include, for example, the Unix™, Linux™, and Microsoft Windows™ operating systems.

Disks 112 can be implemented using conventional disk drives that provide fast read/write access. These may include, for example, hard drives, solid state drives, or flash memory drives. Disks 112 are configured to store metadata and a table that maps metadata to its corresponding data stored on tapes 114. Tapes 114 can be implemented using conventional tape storage devices. Tapes 114 store both the metadata stored on disks 112 and its corresponding data. In this way, corrupt metadata on disks 112 can be restored from the metadata stored on tapes 114. In some embodiments, disks 112 and tapes 114 can be arranged in storage system 100 such that the capacity of disks 112 are about five percent of the capacity of tapes 114.

As discussed above, tape aggregate 110 may be configured such that users can read and write data using a variety of file systems and I/O interfaces. The file systems and interfaces may be implemented through code executed by tape aggregate controller 116. The file system implemented by tape controller 116 may include storage objects comprising one or more storage volumes, where each volume has a file system implemented on the volume. A file system may provide multiple directories in a single volume, each directory containing various filenames. A file system provides a logical representation of how data (files) are organized on a volume where data (files) are represented as filenames that are organized into one or more directories. Examples of common file systems include New Technology File System (NTFS), File Allocation Table (FAT), Hierarchical File System (HFS), Universal Storage Device Format (UDF), Unix™ file system, and the like. For the Data ONTAP™ storage operating system (available from NetApp, Inc. of Sunnyvale, Calif.) which may implement a Write Anywhere File Layout (WAFL™) file system, there is typically a WAFL™ file system within each volume, and within a WAFL file system, there may be one or more logical units (LUs). The scope of embodiments is not limited to any particular storage operating system or file system.

In some embodiments, tape aggregate controller 116 may implement a tape aggregate interface layer for accessing the data stored on disks 112 and tapes 114. Tape aggregate interface layer provides a Physical Volume Block Number (PVBN) space that addresses blocks on the disks for storing metadata. Disks 112 also store a PVBN-TBN map that maps a physical volume block numbers to a specific tape and block on tapes 114. Each entry in the PVBN-TBN includes a physical volume block number, a tape block number, and a tape identifier. In some embodiments, a tape block number indicates the offset from the beginning of a tape where a block of data is stored. Further, tape identifiers can be unique identifiers or numbers such that each tape is distinguishable from another tape. Reading and writing data and metadata to storage systems such as tape aggregate 110 is discussed below in reference to Figures 300 and 400.

In some embodiments, tape aggregate controller 116 also implements a volume container layer 120 that provides a Virtual Volume Block Number (VVBN) space. An example of a VVBN space is the Write Anywhere File Layout (WAFL™), discussed above. The VVBN space is similar to the PVBN space but allows the PVBN to be divided into multiple and possibly diverse storage volumes. The VVBN space maps to the PVBN such that storage blocks in disks 112 and tapes 114 can be accessed for reading and writing data.

In some embodiments, tape aggregate controller 116 also may implement a file system layer 140 that provides direct read/write access to data files stored on disks 112 and tapes 114. An example of file system layer 140 is WAFL file system, discussed above. The file system layer 140 operates as file systems known in the art in that users can read, write, and otherwise interact with data files rather than the blocks that hold that data. To accomplish this, file system layer 140 uses the volume container layer 120 to construct a listing of data files stored in the blocks of disks 112 and tapes 114. Because file system layer 140 must respond quickly to requests, the metadata stored on disks 112 is used to construct representations of the data files stored on tapes 114. Requests made using the file system layer 140 are processed through the volume container layer 120 but this processing is essentially invisible to the file system I/O operations.

Read or write requests made using the file system layer 140 may be made through file I/O interface 150. File I/O interface 150 may be implemented using file input and output commands known in the art. For example, file I/O commands provided by an operating system running on storage system 100 may provide access to data files over a network connection or directory through an input device connected to tape aggregate 110. File I/O interface 150 may include, for example, support for logical level I/O operations according to the Logical Replication Engine with Storage Efficiency (“LRSE”) format provided by the SnapMirror® data protection software (available from NetApp, Inc. of Sunnyvale, Calif.). LRSE provides mirror and replicate functionality such that data on another storage volume can be backed-up at the logical level of the file system.

In embodiments that support LRSE operations, a back-up initialization and update session from a storage volume to tape aggregate 110 may precede as a data transfer involving two phases—a data phase and a metadata phase. The data phase is performed first and includes opening a stream using file I/O interface 150, receiving data according to the LRSE operation, writing the data to tapes 114, updating the metadata stored on disks 112 including, for example, the PVBN-TBN map and the metadata offset map while the data is streamed to tapes 114, and closing the stream. The metadata phase is performed next and includes writing the metadata describing the stored data to disks 112 and tapes 114 and updating the metadata stored on disks 112 including, for example, the PVBN-TBN and the metadata offset map.

Further, in embodiments that support LRSE operations, a full volume or partial restore from tape aggregate 110 to another data storage volume may be performed using file I/O interface 150. First, an LRSE operation opens a stream using file I/O interface 150. Interface 150 then processes one or more LRSE file read operations and converts them into one or more operations for retrieving the requested files from tapes 114. In other words, as the LRSE read operations access files of a volume stored on tape aggregate 110, interface 150 converts the read operations such that the requested files from tapes 114 can be retrieved. Interface 150 also retrieves the metadata associated with the requested files from disks 112. The files and metadata are then reconstructed and provided in response to the read operations.

Further, in embodiments that support LRSE operations, a full volume or partial restore from tape aggregate 110 to another data storage volume may be performed using file I/O interface 150. First, an LRSE operation opens a stream using file I/O interface 150. Interface 150 then processes one or more LRSE file read operations and converts them into one or more operations for retrieving the requested files from tapes 114. In other words, as the LRSE read operations access files of a volume stored on tape aggregate 110, interface 150 converts the read operations such that the requested files from tapes 114 can be retrieved. Interface 150 also retrieves the metadata associated with the requested files from disks 112. The files and metadata are then reconstructed and provided in response to the read operations.

Further, in embodiments that support LRSE operations, a single file may be restored from tape aggregate 110 using file I/O interface 150. First, a file read operation is received by interface 150. Interface 150 then identifies a list of VVBNs to be read according to the file read operation and translates the list of VVBNs to PVBNs. The list of PVBNs is then sorted and each PVBN is read from tapes 114 in sequential order. The requested file is then reconstructed and provided in response to the read operation.

In some embodiments, tape aggregate 110 may also implement a data stream interface 130. Data stream interface 130 may be implemented such that a stream of data can be written directly, with a stream identified by a stream identifier. The stream of data is written to tape sequentially (applying the same algorithm for each datablock). This stream of data can be read back in the same way by providing the stream identifier. Data protection software such as, for example, a Block Replication Engine (“BRE”) component provided with the SnapMirror® data protection software can use this stream interface to efficiently perform replication and full volume restores. BRE provides mirror and replicate functionality such that data on another storage volume can be backed-up at the block level. Data stream interface 130 provides a faster way of reading and writing large blocks of data from the tape aggregate storage system 110 as compared to file I/O interface 150 since the tapes 114 do not have to be continually searched for the position of the desired data.

In some embodiments, a write stream operation may be implemented by, for example, first receiving the data portion and sequentially writing the data portion to tapes 114 and second receiving the metadata portion and sequentially writing the metadata portion to tapes 114 and disks 112. Similarly, a read stream operation may be implemented by, for example, reading all of the data from each of the associated blocks from tapes 114 and disregarding or deleting the portion of read data that is not required. In some embodiments, other I/O operations such as, for example, file I/O and other stream operations are paused while a particular read or write stream operation is in progress. Further, in some embodiments, data stored via the stream write operation may include a stream identifier that is matched with a snapshot or transfer identifier. In this way, the data may be located by a stream read operation by using the stream identifier.

In some embodiments, tapes 114 are formatted to allow data to be written in the form of chunks. A chunk is a sequence of data blocks with a maximum size such as, for example, 2 MB. Each chunk includes a header field that stores information such as, for example, the type of the chunk, an aggregate identifier, the number of blocks in the chunk, the PVBN numbers for the blocks in the chunks, stream identifiers for assisting with data stream I/O operations, checksums, and other relevant information. The format of tapes 114 may also support writing of data streams where streamed data will be stored as sequential chunks of data with the same stream identifier set in each associated chunk header.

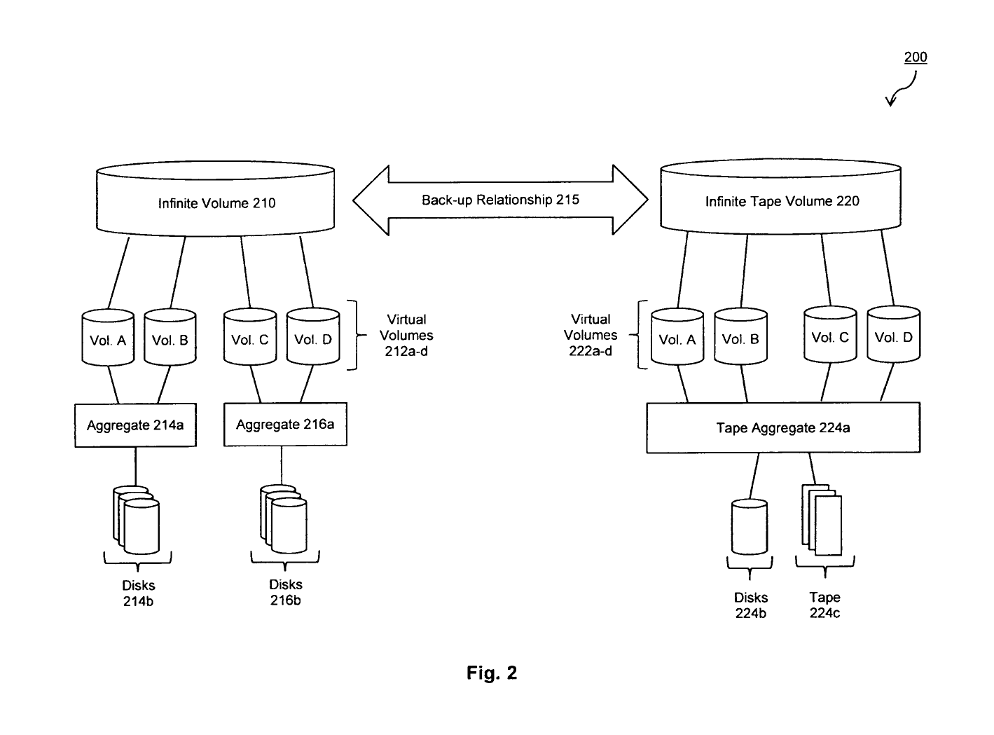

FIG. 2 is a simplified block diagram of a backup system 200 that shows an example relationship 215 between an infinite volume storage system 210 and an infinite tape volume storage system 220. Relationship 215 is a back-up relationship in that the infinite volume 210 is backed-up or mirrored on infinite tape volume 220. The backup relationship can be performed by data protection software such as, for example, the SnapMirror® data protection software, described above.

Infinite volume storage system 210 includes virtual volumes 212a-d, aggregates 214a and 216a, and disks 214b and 216b. Infinite volume 210 is a very large storage system that may be implemented by a computer system that includes one or more clusters or nodes. Each node may implement an aggregate 214a or 216a and may include one or more disks 214b or 216b. Aggregates 214a and 216a may be mapped to one or more virtual volume such as, for example, virtual volumes 212a-d. Virtual volumes 212a-d may be used to store large volumes of data for quick read and write access.

To back up the infinite volume 210, any of the virtual volumes 212a-d, or any data files stored on the virtual volumes, a backup relationship may be established between the infinite volume and infinite tape volume 220. As described above, infinite tape volume 220 may be available over a network or directly connected to the infinite volume 210. To initialize a backup, a command may be executed to copy the entirety of infinite volume 210 to infinite tape volume 220. Upon receiving the command, infinite tape volume 220 may create a new virtual volume on infinite tape 220 for each of the virtual volumes on infinite volume 210. Virtual volumes 222a-d are examples of replicated virtual volumes 212a-d. While virtual volumes 222a-d are shown as being stored on only one tape aggregate 224a, multiple tape aggregates may be used. In some embodiments, multiple tape aggregates may be implemented each on a computer node or cluster included in the infinite tape volume 210.

As described above in reference to FIG. 1, each tape aggregate 224a includes one or more disks 224b and one or more tapes 224c. In some embodiments, data may be backed up onto the disks 224b and tapes 224c via a data stream interface. As described above, the data stream interface allows for direct writing of data and its corresponding metadata to tape aggregates. In some embodiments, a file system interface is provided whereby backups of data and corresponding metadata can be achieved using file system I/O commands. In this way, infinite tape volume 220 may be used to backup one or more volumes or one or more specific data files. Additionally, restoring data from infinite tape volume 220 to infinite volume 210 may also be performed using either the data stream interface or the file system interface. In this way, one or more volumes may be restored or just a single data file.

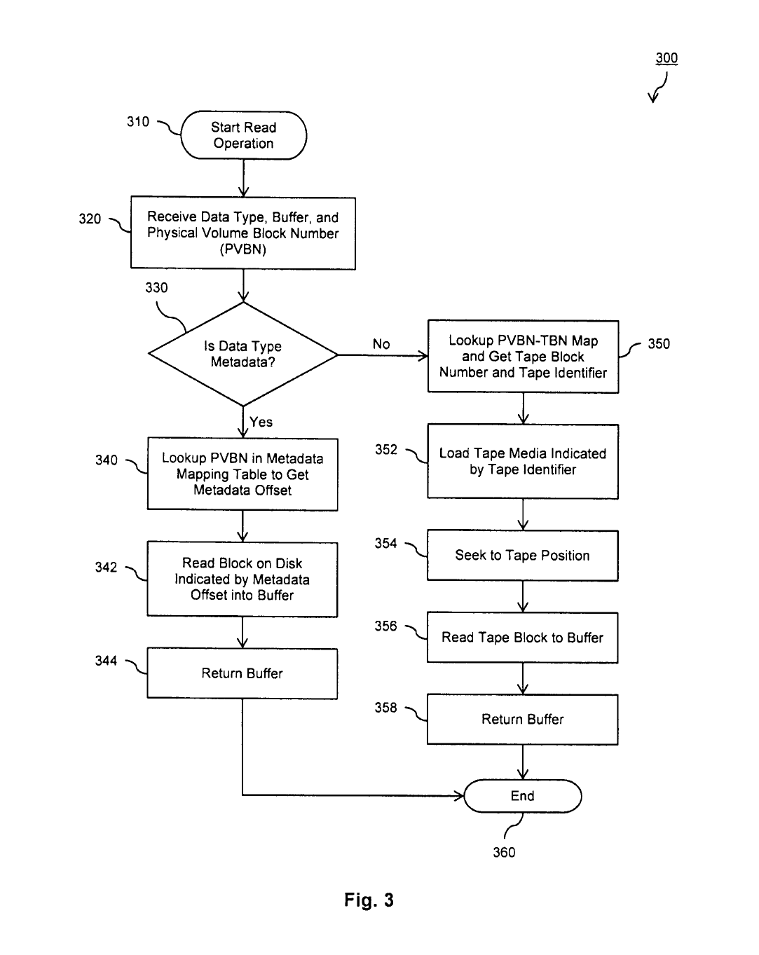

FIG. 3 illustrates an example method 300 for reading data from a tape aggregate storage system according to some embodiments. Method 300 may be implemented by, for example, tape aggregate controller 116 in system 100. In step 310, a read operation is initiated at a tape aggregate in a storage system. The read operation may be passed as a function call through an operating system or an interface layer implemented on the storage system. To locate data in a tape aggregate, the read operation provides a data type variable, a buffer address for storing the requested data, and a Physical Volume Block Number (PVBN) of the data to be read in step 320.

In step 330 it is determined whether the data type variable indicates that metadata is to be read. If metadata is to be read, the PVBN provided with the read operation is used to locate an entry in a metadata mapping table in step 340. The metadata mapping table is stored on a disk component of the tape aggregate and maps PVBNs to offsets within the metadata storage file stored on the disk. Once the entry in the metadata mapping table is located, the offset stored at the entry is used to locate the metadata to be read from the metadata storage file. In step 342, the metadata is copied into the buffer and the buffer is returned to the requesting operation in step 344.

Returning back to step 330, if it is determined that the data type variable indicates that data is to be read, the PVBN provided with the read operations is used to lookup an entry in a PVBN-TBN map in step 350. The PVBN-TBN map is stored on a disk component of the tape aggregate and is used to map PVBNs to tape identifiers and tape block numbers. The tape identifier indicates which tapes store the requested data and the tape block number indicates the offset on the identified tape where the requested data is located. In step 352, the tape indicated by the tape identifier is loaded. The system then seeks to the position on the tape indicated by the tape block number in step 354. Once the tape is at the correct block number, the block is copied into the buffer in step 356 and the buffer is returned to the requesting operation in step 358. Once the metadata or data is read into the buffer, the read operation then ends in step 360.

It should be noted that method 300 may be applied to any tape aggregate in a storage system with a tape aggregate architecture and not just tape aggregates described in systems 100 and 200.

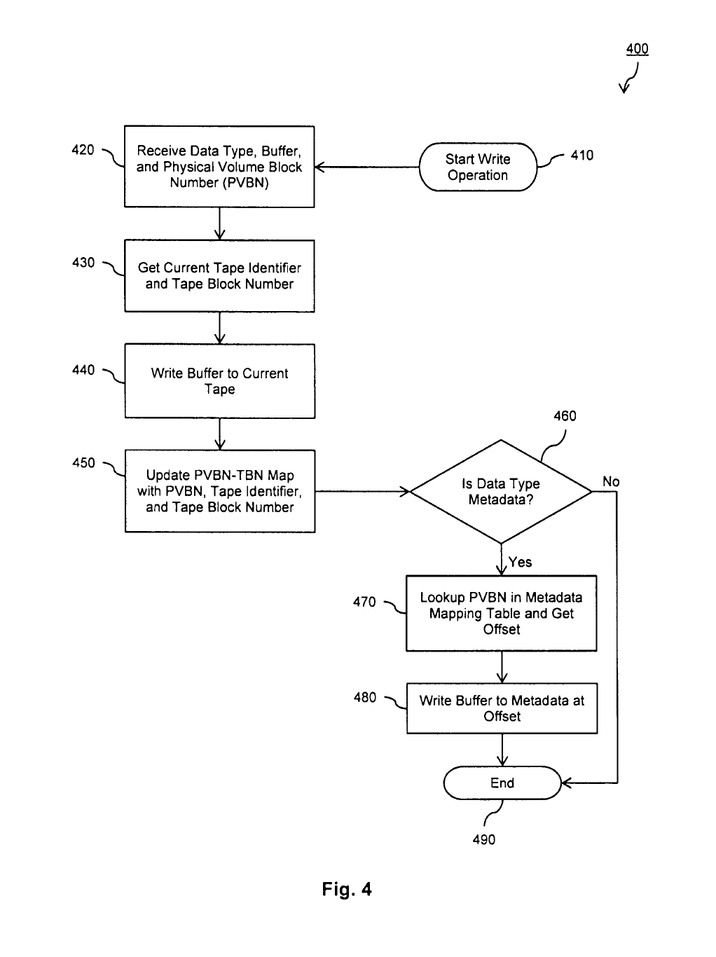

FIG. 4 illustrates an example method 400 for writing data to a tape aggregate storage system according to some embodiments. Method 400 may be implemented by, for example, tape aggregate controller 116 in system 100. In step 410, a write operation is initiated at a tape aggregate in a storage system. The write operation may be passed as a function call through an operating system or interface layer implemented on the storage system. To locate a position to write data in a tape aggregate, the write operation provides a data type variable, a buffer address that points to the data to be written, and a Physical Volume Block Number (PVBN) where the data is to be written in step 420. The data type variable indicates whether the buffer stores data or metadata.

In step 430, the current tape identifier and tape block number are retrieved. The tape identifier is used to uniquely identify each tape and the tape block number indicates the location on the tape for writing data. In step 440, the data stored in the buffer is written to the tape at the block indicated by the tape block number. In step 450, the PVBN-TBN map is then updated with the PVBN provided by the requesting write operation and the tape identifier and tape block number where the data in the buffer was written.

In step 460 it is determined whether the data type variable indicates that metadata was written. If metadata was not written, the write operation ends. If metadata was written, however, the PVBN provided with the write operation is used to locate an entry in a metadata mapping table in step 470. The metadata mapping table is stored on a disk component of the tape aggregate and maps PVBNs to offsets within the metadata storage file. If the offset is not set for the PVBN, then a new offset is determined from the metadata mapping table. In step 480, once the offset is either located or determined, the metadata in the buffer is written to the metadata storage file at the position indicated by the offset. Once the metadata or data is read into the buffer, the read operation then ends in step 490.

It should be noted that method 400 may be applied to any tape aggregate in a storage system with a tape aggregate architecture and not just tape aggregates described in systems 100 and 200.

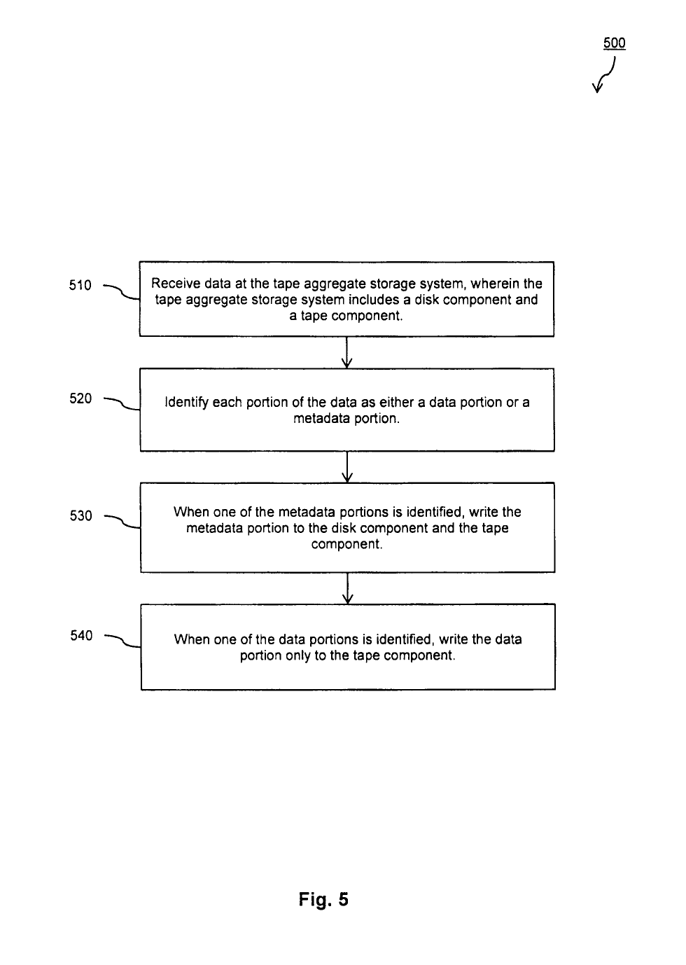

FIG. 5 illustrates an example method 500 for storing data received by a tape aggregate of a storage system according to some embodiments. Method 500 may be carried out by, for example, the tape aggregate controller 116 in system 100. Method 500, however, is not intended to limit the other functions that may be carried out by tape aggregates or their storage systems.

Block 510 includes receiving data at the tape aggregate storage system, wherein the tape aggregate storage system including a disk component and a tape component. The disk component may include one or more storage devices such as, for example, a hard drive, a solid state drive, or a flash memory drive. The tape component may include one or more conventional tape drives. As described above, the tape aggregate storage system is configured to store metadata on disk components and both data and metadata on tape components.

Block 520 includes identifying each portion of the data as either a data portion or a metadata portion. The data portion includes the contents of a data file and the metadata portion includes the attributes or other properties of the data file. In some embodiments the type of data to be stored is identified by a variable that is received with the data.

Block 530 includes writing metadata portions of the data to the disk component and the tape component when one of the metadata portions is identified. Block 540 includes writing the data portion only to the tape component when one of the data portions is identified. The process of writing the metadata portion and the data portion of a data file that is utilized by some embodiments is described in reference to FIG. 4.

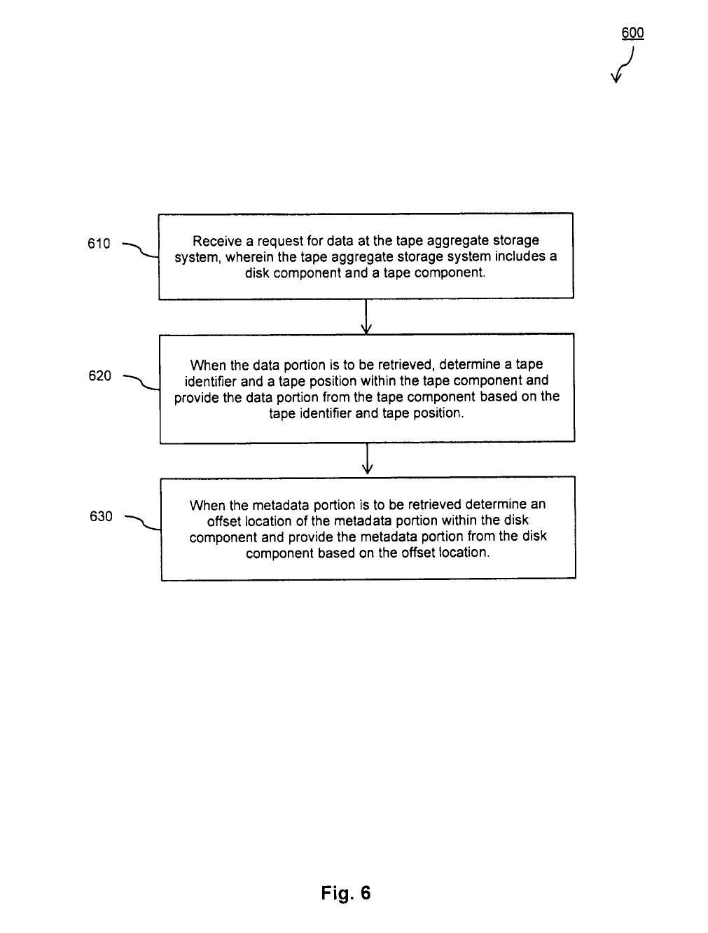

FIG. 6 illustrates an example method 600 for retrieving data from a tape aggregate storage system according to some embodiments. Method 600 may be carried out by, for example, the tape aggregate controller 116 in system 100. Method 600, however, is not intended to limit the other functions that may be carried out by tape aggregates or their storage systems.

Block 610 includes receiving a request for data at the tape aggregate storage system. The tape aggregate storage system includes a disk component and a tape component. The disk component may include one or more storage devices such as, for example, a hard drive, a solid state drive, or a flash memory drive. The tape component may include one or more tape drives.

When the data portion is to be retrieved, block 620 includes determining a tape identifier and a tape position within the tape component and providing the data portion from the tape component based on the tape identifier and tape position. The data portion includes the contents of a data file and the metadata portion includes the attributes or other properties of the data file. In some embodiments the type of data to be retrieved is identified by a variable that is received with the retrieval request.

When the metadata portion is to be retrieved, block 630 includes determining an offset location of the metadata portion within the disk component and providing the metadata portion from the disk component based on the offset location. The process of reading the metadata portion and the data portion of a data file that is utilized by some embodiments is described in reference to FIG. 3.

It should be noted that methods 500 and 600 may be applied to any tape aggregate in a storage system and not just tape aggregates described in systems 100 and 200.

As described above, the embodiments allow file system access to tape-based storage devices as if they were disk-based storage devices. The embodiments provide an advantage over conventional systems because conventional tape-based storage system only provides linear or sequential I/O operations to read or write data on the tapes. This makes browsing the data files stored on the tape-based storage system impractical. In the embodiments described herein, not only are linear I/O operations provided to read and write data on the tapes, but I/O operations are also provided that expose the file system stored on the tapes and allow access to specific files stored on the tapes.

When implemented via computer-executable instructions, various elements of embodiments of the present disclosure are in essence the software code defining the operations of such various elements. The executable instructions or software code may be obtained from a non-transitory, tangible readable medium (e.g., a hard drive media, optical media, RAM, EPROM, EEPROM, tape media, cartridge media, flash memory, ROM, memory stick, network storage device, and/or the like). In fact, readable media can include any medium that can store information.

In the embodiments described above, example system 100 and its tape aggregate can include processor-based devices and may include general-purpose processors or specially-adapted processors (e.g., an Application Specific Integrated Circuit). Such processor-based devices may include or otherwise access the non-transitory, tangible, machine readable media to read and execute the code. By executing the code, the one or more processors perform the actions of methods 300, 400, 500, and/or 600 as described above.

Although illustrative embodiments have been shown and described, a wide range of modification, change and substitution is contemplated in the foregoing disclosure and in some instances, some features of the embodiments may be employed without a corresponding use of other features. One of ordinary skill in the art would recognize many variations, alternatives, and modifications. Thus, the scope of the invention should be limited only by the following claims, and it is appropriate that the claims be construed broadly and in a manner consistent with the scope of the embodiments disclosed herein.

What is claimed is:

1. A method of storing data to an aggregate storage system comprising:
receiving data at the aggregate storage system, wherein the aggregate storage system includes a random-access storage component and a sequential-access storage component, and wherein the data includes one or more data portions and one or more metadata portions;
identifying each portion of the data as either one of the data portions or one of the metadata portions;
in response to determining that one of the metadata portions is identified, writing the metadata portion to the random-access storage component and the sequential-access storage component; and
in response to determining that one of the data portions is identified, writing the data portion only to the sequential-access storage component.

2. The method of claim 1, wherein the sequential-access storage component includes a plurality of sequential-access drives that are configured to function as one contiguous unit, each sequential-access drive accessible by a unique identifier.

3. The method of claim 1, wherein the random-access storage component includes a one or more random-access storage drives, each random-access storage drive being either a magnetic drive or a solid state drive, and the sequential-access component includes a plurality of magnetic tape drives, and wherein the random-access storage component storage capacity is about five percent of the sequential-access storage component storage capacity.

4. The method of claim 1, further comprising:
providing a first communication interface implemented by the aggregate storage system that supports reading a particular data file from and writing a particular data file to the aggregate storage system.

5. The method of claim 1, further comprising:
providing a second communication interface implemented by the aggregate storage system that supports reading a stream of data from and writing a stream of data to the aggregate storage system.

6. The method of claim 5, wherein the second communication interface supports receiving a first stream of data that includes only a metadata portion and writing the metadata portion to the random-access storage component and the sequential-access storage component, and wherein the second communication interface supports receiving a second stream of data that includes only a data portion and writing the data portion only to the sequential-access storage component.

7. The method of claim 1, further comprising:
receiving a request to retrieve data stored by the aggregate storage system, wherein the request includes an indication of whether data or metadata is to be retrieved;
in response to determining that data is to be retrieved:
determining a sequential-drive identifier and a sequential-drive position within the sequential-access storage component where the data is stored; and
providing the data from the sequential-access storage component based on the sequential-drive identifier and the sequential-drive position.
in response to determining that metadata is to be retrieved:
determining an offset location of the metadata within the random-access storage component; and
providing the metadata from the random-access storage component based on the offset location.

8. An apparatus comprising a non-transitory, tangible computer readable storage medium storing a computer program, wherein the computer program has instructions that, when executed by a computer processor, carry out the method comprising:
receiving a request for data at an aggregate storage system, wherein the aggregate storage system includes a first media storage component and a second media storage component, and wherein the request includes an indication that the type of data is either a data portion or a metadata portion of the data;
in response to determining that the data portion is to be retrieved:
determining a second media drive identifier and a second media drive position within the second media storage component where the data portion is stored; and
providing the data portion from the second media storage component based on the second media drive identifier and the second media drive position; and
in response to determining that the metadata portion is to be retrieved:
determining an offset location of the metadata portion within the first media storage component; and
providing the metadata portion from the first media storage component based on the offset location.

9. The apparatus of claim 8, wherein the second media storage component includes a plurality of magnetic tape drives that are configured to function as one contiguous unit, each magnetic tape drive accessible by a unique identifier.

10. The apparatus of claim 8, wherein the first media storage component includes a one or more random-access drives and the second media storage component includes a plurality of sequential-access drives, and where the first media storage component storage capacity is about five percent of the second media storage component storage capacity.

11. The apparatus of claim 8, further comprising:
providing a first communication interface implemented by the aggregate storage system that supports reading a particular data file from aggregate storage system.

12. The apparatus of claim 8, further comprising:
providing a second communication interface implemented by the aggregate storage system that supports reading a stream of data from the aggregate storage system.

13. The apparatus of claim 8, further comprising:
providing a first communication interface implemented by the aggregate storage system that supports reading a particular data file from the aggregate storage system;
providing a second communication interface implemented by the aggregate storage system that supports reading a stream of data from the aggregate storage system.

14. An aggregate storage system for reading and writing data comprising:
one or more first media storage components configured to store a metadata portion of the data;
one or more second media storage components configured to store the metadata portion and a data portion of the data;
an aggregate controller configured to execute a write operation and a read operation,
wherein the write operation comprises:
receiving the data at the aggregate storage system;
identifying each portion of the data as either a data portion or a metadata portion;
in response to determining that one of the metadata portions is identified, writing the metadata portion to the first media storage component and the second media storage component; and
in response to determining that one of the data portions is identified, writing the data portion only to the second media storage component; and
wherein the read operation comprises:
receiving a request for the data at the aggregate storage system, wherein the request includes an indication that the type of the data is either the data portion or the metadata potion of the data;
in response to determining that the data portion is to be retrieved:
determining a second media drive identifier and a second media drive position within the second media storage component where the data portion is stored; and
providing the data portion from the second media storage component based on the second media drive identifier and second media drive position; and
in response to determining that the metadata portion is to be retrieved:
determining an offset location of the metadata portion within the first media storage component; and
providing the metadata portion from the first media storage component based on the offset location.

15. The system of claim 14, wherein the second media storage component includes a plurality of magnetic tape drives that are configured to function as one contiguous unit, each magnetic tape drive accessible by a unique identifier.

16. The system of claim 14, wherein the first media storage component includes one or more random-access storage drives and the second media storage component includes a plurality of magnetic tape drives, and where the first media storage component storage capacity is about five percent of the second media storage component storage capacity.

17. The system of claim 14, wherein the aggregate controller is further configured to execute a file system interface that supports reading a particular data file from and writing a particular data file to the aggregate storage system.

18. The system of claim 14, wherein the aggregate controller is further configured to execute a data streaming interface that supports reading a stream of data from and writing a stream of data to the aggregate storage system.

19. The system of claim 18, wherein the data streaming interface supports receiving a first stream of data that includes only a metadata portion and writing the metadata portion to the first media storage component and the second media storage component and a second stream of data that includes only a data portion and writing the data portion only to the second media storage component.

20. The system of claim 14, wherein the aggregate controller is further configured to execute:
a file system interface that supports reading a particular data file from or writing a particular data file to the aggregate storage system; and
a data streaming interface that supports reading a stream of data from or writing a stream of data to the aggregate storage system.
